(19) United States
(12) Patent Application Publication
(10) Pub. No.: US 2022/0161652 A1
(43) Pub. Date: May 26, 2022

(54) FRONT-AND-REAR-WHEEL-DRIVE VEHICLE

(71) Applicant: JTEKT CORPORATION, Kariya-shi (JP)

(72) Inventor: Noriyuki FUJII, Hekinan-shi (JP)

(73) Assignee: JTEKT CORPORATION, Kariya-shi (JP)

(21) Appl. No.: 17/455,262

(22) Filed: Nov. 17, 2021

(30) Foreign Application Priority Data
Nov. 26, 2020 (JP) 2020-196054

(51) Int. Cl. B60K 17/348; B60K 17/356; B60K 17/16; F16H 37/06; F16H 3/085; B60K 6/48; B60K 6/36; B60K 6/547; B60K 6/52

(52) U.S. Cl. CPC B60K 17/348; B60K 17/356; B60K 17/16; F16H 37/065; F16H 3/085; B60K 2006/4816; B60K 6/36; B60K 6/547; B60K 6/52; B60Y 2200/92; B60K 6/48

(57) ABSTRACT

A front-and-rear-wheel-drive vehicle includes an electric motor; a speed change mechanism; a first output rotation shaft that transmits a drive force of the electric motor that has been transmitted to an intermediate output member, to one of a front wheel side and a rear wheel side; and a second output rotation shaft that transmits the drive force that has been transmitted to the intermediate output member, to another of the front wheel side and the rear wheel side. The first and second output rotation shafts are disposed coaxially with the intermediate output member. The electric motor is disposed such that a rotation axis of a motor shaft is positioned in parallel with a rotation axis of the intermediate output member and the first and second output rotation shafts and vertically above the rotation axis of the intermediate output member and the first and second output rotation shafts.

### CROSS-REFERENCE TO RELATED APPLICATION

This application claims priority to Japanese Patent Application No. 2020-196054 filed on Nov. 26, 2020, incorporated herein by reference in its entirety.

### BACKGROUND

### 1. Technical Field

The disclosure relates to a front-and-rear-wheel-drive vehicle in which front wheels and rear wheels are configured to be driven.

### 2. Description of Related Art

Conventionally, as a front-and-rear-wheel-drive vehicle including an electric motor capable of driving front wheels and rear wheels as a drive source, an electric vehicle described in Japanese Unexamined Patent Application Publication No. 2004-58700 has been known. A drive device of the electric vehicle includes an electric motor, a front drive shaft extending through a tubular rotor shaft disposed at a center portion of the electric motor, a rear drive shaft disposed coaxially with the front drive shaft, a front-and-rear-wheel differential mechanism disposed between the front drive shaft and the rear drive shaft, and a planetary gear disposed between the front-and-rear-wheel differential mechanism and the electric motor. The front-and-rear-wheel differential mechanism includes a differential case to which a rotational force of the electric motor is transmitted after the speed of the rotation is reduced by the planetary gear, a pinion shaft attached to the differential case, a plurality of pinion gears rotatably supported on the pinion shaft, and a pair of side gears that meshes with the plurality of pinion gears such that a gear shaft of the pair of side gears extends perpendicularly to that of the plurality of pinion gears. The front drive shaft is connected to one side gear and the rear drive shaft is connected to the other side gear. The electric motor includes a rotor attached to an outer circumference of the rotor shaft, and a stator surrounding an outer circumference of the rotor. The rotor and the stator are housed in a motor case.

### SUMMARY

In the vehicle disclosed in JP 2004-58700 A, the front drive shaft and the rear drive shaft are disposed coaxially with the electric motor, and thus, a part of the motor case is located below the front drive shaft and the rear drive shaft. Here, a front-and-rear-wheel-drive vehicle, in which front wheels and rear wheels are configured to be driven, often travels on an unpaved rough road in comparison with two-wheel-drive vehicles such as an FF vehicle and an FR vehicle. Therefore, it is necessary to secure a sufficient minimum ground clearance. However, if a part of a motor case is located below a front drive shaft and a rear drive shaft, the minimum ground clearance is determined by the motor case, which may result in failure to secure a sufficient minimum ground clearance.

The disclosure provides a front-and-rear-wheel-drive vehicle having a configuration in which a minimum ground clearance is less likely to be limited by an electric motor that is a drive source.

An aspect of the disclosure relates to a front-and-rear-wheel-drive vehicle in which front wheels and rear wheels are configured to be driven. The front-and-rear-wheel-drive vehicle includes an electric motor including a motor shaft that rotates when the electric motor is supplied with an electric current; a speed change mechanism configured to change a speed of rotation of the motor shaft to a plurality of levels and to output resulting rotation from an intermediate output member; a first output rotation shaft that transmits a drive force of the electric motor that has been transmitted to the intermediate output member, to one of a front wheel side and a rear wheel side; and a second output rotation shaft that transmits the drive force of the electric motor that has been transmitted to the intermediate output member, to another of the front wheel side and the rear wheel side. The first and second output rotation shafts are disposed coaxially with the intermediate output member. The electric motor is disposed such that a rotation axis of the motor shaft is positioned in parallel with a rotation axis of the intermediate output member and the first and second output rotation shafts and vertically above the rotation axis of the intermediate output member and the first and second output rotation shafts.

According to the above-aspect of the disclosure, it is possible to easily secure a sufficient minimum ground clearance in a front-and-rear-wheel-drive vehicle including an electric motor as a drive source.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a drive system of a front-and-rear-wheel-drive vehicle according to a first embodiment;

FIG. 2 is a configuration diagram illustrating a configuration of a part of a drive force distribution device according to the first embodiment;

FIG. 3 is a schematic configuration diagram of a drive system of a front-and-rear-wheel-drive vehicle according to a second embodiment;

FIG. 4 is a configuration diagram illustrating a configuration of a part of a drive force distribution device according to the second embodiment;

FIG. 5 is a schematic configuration diagram of a drive system of a front-and-rear-wheel-drive vehicle according to a third embodiment;

FIG. 6 is a configuration diagram illustrating a configuration of a part of a drive force distribution device according to the third embodiment;

FIG. 7 is a schematic configuration diagram of a drive system of a front-and-rear-wheel-drive vehicle according to a fourth embodiment; and

FIG. 8 is a configuration diagram illustrating a configuration of a part of a drive force distribution device according to the fourth embodiment.

### DETAILED DESCRIPTION OF EMBODIMENTS

### First Embodiment

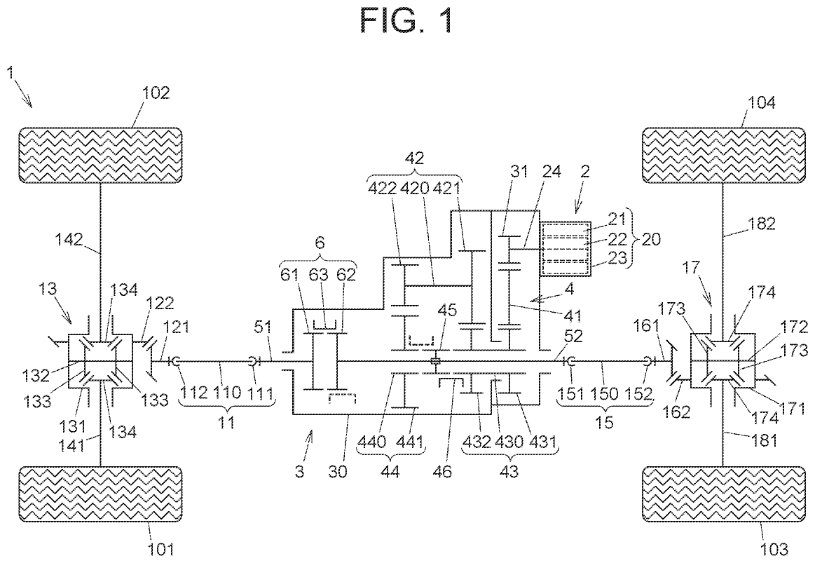

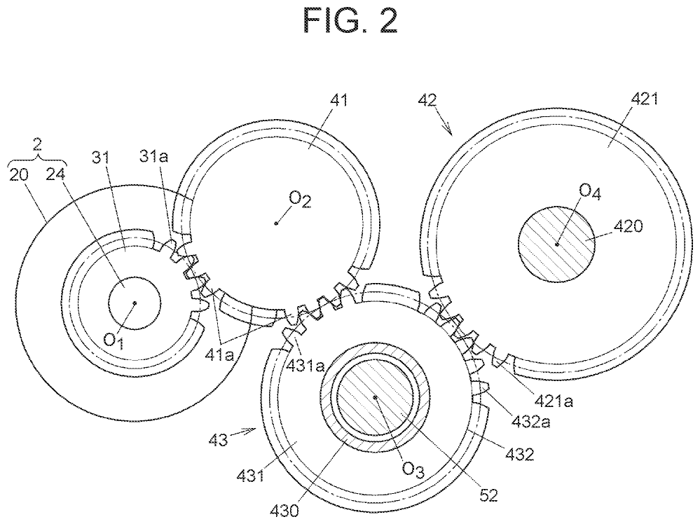

A first embodiment of the disclosure will be described with reference to FIGS. 1 and 2. Note that embodiments described below are provided as specific examples, and the technical scope of the disclosure is not limited to these specific examples.

FIG. 1 is a schematic configuration diagram of a drive system of a front-and-rear-wheel-drive vehicle according to a first embodiment of the disclosure. FIG. 2 is a configuration diagram illustrating a configuration of a part of a drive force distribution device in the front-and-rear-wheel-drive vehicle.

The front-and-rear-wheel-drive vehicle 1 includes an electric motor 2 that is a drive source, and a drive force distribution device 3 configured to distribute a drive force of the electric motor 2 to the left and right front wheel 101, 102-side and the left and right rear wheel 103, 104-side. In the below description, “front side” refers to the front side in a vehicle front-rear direction of the front-and-rear-wheel-drive vehicle 1 and “rear side” refers to the rear side in the vehicle front-rear direction of the front-and-rear-wheel-drive vehicle 1.

The electric motor 2 is, for example, a three-phase alternating-current motor, and functions as an electric power generator that generates regenerative electric power during deceleration in addition to generating a drive force via an electric current supplied from a non-illustrated inverter device. The electric motor 2 includes a body 20 including a motor case 23 that houses a stator 21 and a rotor 22, and a motor shaft 24 projecting from the motor case 23. The stator 21 includes a coil wounded around each of teeth of a core surrounding an outer circumference of the rotor 22 and generates a rotating magnetic field via an electric current supplied to the coils. The rotor 22 includes a plurality of permanent magnets provided at the outer circumference and rotates integrally with the motor shaft 24 via the magnetic field generated in the stator 21. A rotation axis of the motor shaft 24 is parallel to the vehicle front-rear direction. The body 20 of the electric motor 2 is attached to an end portion on the rear side of the drive force distribution device 3.

The front-and-rear-wheel-drive vehicle 1 includes a front propeller shaft 11, a pinion gear shaft 121 connected to a front end portion of the front propeller shaft 11, a ring gear 122 that meshes with the pinion gear shaft 121, a front differential 13 including a differential case 131 that rotates integrally with the ring gear 122, and left and right drive shafts 141, 142 as components for transmitting a drive force from the drive force distribution device 3 to the left and right front wheels 101, 102.

The front propeller shaft 11 extends in the vehicle front-rear direction and transmits a drive force to the front wheel 101, 102-side. The front propeller shaft 11 includes a cylindrical or columnar shaft portion 110, and joints 111, 112, such as cross-joints, which are provided at respective end portions on the rear side and the front side of the shaft portion 110. The pinion gear shaft 121 is swingably connected to the shaft portion 110 via the joint 112. The front differential 13 includes the differential case 131, a pinion pin 132 that rotates integrally with the differential case 131, a plurality of pinion gears 133 rotatably supported on the pinion pin 132, and a pair of side gears 134 that meshes with the plurality of pinion gears 133. The side gears 134 are non-rotatably connected to the left and right drive shafts 141, 142, respectively.

Also, the front-and-rear-wheel-drive vehicle 1 includes a rear propeller shaft 15, a pinion gear shaft 161 connected to a rear end portion of the rear propeller shaft 15, a ring gear 162 that meshes with the pinion gear shaft 161, a rear differential 17 including a differential case 171 that rotates integrally with the ring gear 162, and left and right drive shafts 181, 182, as components for transmitting a drive force from the drive force distribution device 3 to the left and right rear wheels 103, 104.

The rear propeller shaft 15 extends in the vehicle front-rear direction and transmits a drive force to the rear wheel 103, 104 side. The rear propeller shaft 15 includes a cylindrical or columnar shaft portion 150, and joints 151, 152 provided at respective end portions on the front side and the rear side of the shaft portion 150. The pinion gear shaft 161 is swingably connected to the shaft portion 150 via the joint 152. The rear differential 17 includes the differential case 171, a pinion pin 172 that rotates integrally with the differential case 171, a plurality of pinion gears 173 rotatably supported on the pinion pin 172, and a pair of side gears 174 that meshes with the plurality of pinion gears 173. The left and right drive shafts 181, 182 are non-rotatably connected to the pair of side gears 174, respectively.

The drive force distribution device 3 is switchable between a four-wheel-drive state in which a drive force of the electric motor 2 is distributed to the front propeller shaft 11 and the rear propeller shaft 15 and a two-wheel-drive state in which a drive force of the electric motor 2 is distributed only to the rear propeller shaft 15. In the below, a configuration of the drive force distribution device 3 will be described in detail.

The drive force distribution device 3 includes a housing 30 fixed to a vehicle body, an input gear 31 fixed to the motor shaft 24 of the electric motor 2, a speed change mechanism 4, first and second output rotation shafts 51, 52, and a connection-disconnection clutch 6. The speed change mechanism 4 can change a speed of rotation of the motor shaft 24 of the electric motor 2 to a plurality of levels and output the resulting rotation from an intermediate output member 45. The first output rotation shaft 51 transmits the drive force of the electric motor 2 that has been transmitted to the intermediate output member 45, to the front wheel 101, 102-side. The second output rotation shaft 52 transmits the drive force of the electric motor 2 that has been transmitted to the intermediate output member 45, to the rear wheel 103, 104-side.

Respective end portions of the first output rotation shaft 51 and the second output rotation shaft 52 project from the housing 30 in the vehicle front-rear direction. The first output rotation shaft 51 is connected to the front propeller shaft 11 and the second output rotation shaft 52 is connected to the rear propeller shaft 15. More specifically, the joint 111 of the front propeller shaft 11 is fixed to a front end portion of the first output rotation shaft 51, and the shaft portion 110 is swingably connected to the first output rotation shaft 51 via the joint 111. Also, the joint 151 of the rear propeller shaft 15 is fixed to a rear end portion of the second output rotation shaft 52, and the shaft portion 150 is swingably connected to the second output rotation shaft 52 via the joint 151.

The first output rotation shaft 51 and the second output rotation shaft 52 are disposed coaxially with the intermediate output member 45 along the vehicle front-rear direction. The first output rotation shaft 51 extends through the intermediate output member 45 in the vehicle front-rear direction and is fitted to the intermediate output member 45 in such a manner as to be non-rotatable relative to the intermediate output member 45. The connection-disconnection clutch 6 is disposed between the first output rotation shaft 51 and the second output rotation shaft 52, at a position ahead of (forward of) the intermediate output member 45.

In the present embodiment, as described above, the first output rotation shaft 51 transmits a drive force to the front wheel 101, 102-side and the second output rotation shaft 52 transmits the drive force to the rear wheel 103, 104-side. However, the arrangement in the drive force distribution device 3 in a front-rear direction may be changed such that the second output rotation shaft 52 transmits a drive force to the front wheel 101, 102-side and the first output rotation shaft 51 transmits the drive force to the rear wheel 103, 104-side.

The speed change mechanism 4 includes an idle gear 41, a multi-stage gear 42, a high speed-side rotary member 43, a low speed-side rotary member 44, an intermediate output member 45 and a sleeve 46. The idle gear 41 meshes with the input gear 31. A pitch diameter of the idle gear 41 is larger than a pitch diameter of the input gear 31. The multi-stage gear 42 includes a large-diameter gear portion 421 and a small-diameter gear portion 422 having different pitch diameters, and a connecting shaft 420 connecting the large-diameter gear portion 421 and the small-diameter gear portion 422 in such a manner that the large-diameter gear portion 421 and the small-diameter gear portion 422 are non-rotatable relative to each other. The large-diameter gear portion 421 has a pitch diameter that is larger than the pitch diameter of the small-diameter gear portion 422, and rotates integrally with the small-diameter gear portion 422.

The high speed-side rotary member 43 includes a first gear portion 431 that meshes with the idle gear 41, a second gear portion 432 that meshes with the large-diameter gear portion 421 of the multi-stage gear 42, and a cylindrical hollow connecting shaft 430 connecting the first gear portion 431 and the second gear portion 432 in such a manner that the first gear portion 431 and the second gear portion 432 are non-rotatable relative to each other. The first gear portion 431 and the second gear portion 432 are fixed to an outer circumference of the hollow connecting shaft 430. The low speed-side rotary member 44 includes a gear portion 441 that meshes with the small-diameter gear portion 422 of the multi-stage gear 42, and a cylindrical hollow connecting shaft 440. The gear portion 441 is fixed to an outer circumference of the hollow connecting shaft 440.

The intermediate output member 45 has a cylindrical shape having a diameter that is the same as those of the hollow connecting shaft 430 of the high speed-side rotary member 43 and the hollow connecting shaft 440 of the low speed-side rotary member 44. The intermediate output member 45 is disposed between the hollow connecting shaft 430 of the high speed-side rotary member 43 and the hollow connecting shaft 440 of the low speed-side rotary member 44. The second output rotation shaft 52 is inserted through the hollow connecting shaft 430 of the high speed-side rotary member 43 and the hollow connecting shaft 440 of the low speed-side rotary member 44. The high speed-side rotary member 43 and the low speed-side rotary member 44 are disposed coaxially with the second output rotation shaft 52.

The sleeve 46 is a cylindrical connecting member disposed on an outer circumference of the intermediate output member 45, and is axially moved between a first connection position at which the sleeve 46 connects the intermediate output member 45 and the hollow connecting shaft 430 of the high speed-side rotary member 43 in such a manner that the intermediate output member 45 and the hollow connecting shaft 430 are non-rotatable relative to each other and a second connection position at which the sleeve 46 connects the intermediate output member 45 and the hollow connecting shaft 440 of the low speed-side rotary member 44 in such a manner that the intermediate output member 45 and the hollow connecting shaft 440 are non-rotatable relative to each other, by power of a non-illustrated actuator. Inner teeth are formed at an inner circumferential surface of the sleeve 46, and outer teeth that mesh with the inner teeth of the sleeve 46 are formed at an outer circumferential surface of the intermediate output member 45 and respective outer circumferential surfaces of parts of the hollow connecting shafts 430, 440, the parts being in the vicinity of the intermediate output member 45. In FIG. 1, the sleeve 46 located at the first connection position is indicated by a solid line and the sleeve 46 located at the second connection position is indicated by a dashed line.

The intermediate output member 45 is connected to one of the high speed-side rotary member 43 and the low speed-side rotary member 44 by the sleeve 46 in such a manner as to be non-rotatable relative to the one of the high speed-side rotary member 43 and the low speed-side rotary member 44. When the sleeve 46 is located at the first connection position, the intermediate output member 45 and the high speed-side rotary member 43 are connected in such a manner as to be non-rotatable relative to each other and the intermediate output member 45 and the low speed-side rotary member 44 are rotatable relative to each other. Also, when the sleeve 46 is located at the second connection position, the intermediate output member 45 and the low speed-side rotary member 44 are connected in such a manner as to be non-rotatable relative to each other and the intermediate output member 45 and the high speed-side rotary member 43 are rotatable relative to each other.

In a first connection state in which the first sleeve 46 is located at the first connection position, a drive force of the electric motor 2 is transmitted from the motor shaft 24 to the intermediate output member 45 through the input gear 31, the idle gear 41, the first gear portion 431 and the hollow connecting shaft 430 of the high speed-side rotary member 43 and the sleeve 46. On the other hand, in a second connection state in which the sleeve 46 is located at the second connection position, a drive force of the electric motor 2 is transmitted from the motor shaft 24 to the intermediate output member 45 through the input gear 31, the idle gear 41, the first gear portion 431 and the second gear portion 432 of the high speed-side rotary member 43, the large-diameter gear portion 421 and the small-diameter gear portion 422 of the multi-stage gear 42, the gear portion 441 and the hollow connecting shaft 440 of the low speed-side rotary member 44 and the sleeve 46.

As described above, in the second connection state, a drive force of the electric motor 2 is transmitted to the intermediate output member 45 through the multi-stage gear 42. Thus, in comparison with the first connection state, a speed reducing ratio in the part from the input gear 31 to the intermediate output member 45 is large and the drive force of the electric motor 2 is largely amplified and transmitted to the intermediate output member 45. Therefore, for example, at the time of a start and in a low speed range, the front-and-rear-wheel-drive vehicle 1 travels in the second connection state and in an intermediate and high speed range, the front-and-rear-wheel-drive vehicle 1 travels with the connection state switched to the first connection state. This enables the electric motor 2 to operate in a high efficiency range in which energy efficiency is high, over a wide vehicle speed range.

The connection-disconnection clutch 6 includes a first disc 61 that rotates integrally with the first output rotation shaft 51, a second disc 62 that rotates integrally with the second output rotation shaft 52, and a cylindrical sleeve 63 that axially moves relative to the first disc 61 and the second disc 62. Outer teeth that mesh with inner teeth of the sleeve 63 are formed at the first disc 61 and the second disc 62. The sleeve 63 moves between a connection position at which the sleeve 63 connects the first disc 61 and the second disc 62 in such a manner that the first disc 61 and the second disc 62 are non-rotatable relative to each other and a non-connection position at which the sleeve 63 allows the first disc 61 and the second disc 62 to be rotatable relative to each other, due to motive power of a non-illustrated actuator. In FIG. 1, the sleeve 63 located at the connection position is indicated by a solid line and the sleeve 63 located at the non-connection position is indicated by a dashed line.

When the sleeve 63 is located at the connection position, a differential motion between the first output rotation shaft 51 and the second output rotation shaft 52 is restricted, and a rotational force of the intermediate output member 45 is transmitted to the first output rotation shaft 51 and the second output rotation shaft 52, which brings the front-and-rear-wheel-drive vehicle 1 into a four-wheel-drive state. On the other hand, when the sleeve 63 is located at the non-connection position, no torque of the intermediate output member 45 is transmitted to the first output rotation shaft 51, which brings the front-and-rear-wheel-drive vehicle 1 into a two-wheel-drive state. The connection-disconnection clutch 6 is switchable between a connection state in which the first output rotation shaft 51 and the second output rotation shaft 52 are connected in such a manner as to be non-rotatable relative to each other and a disconnection state in which the first output rotation shaft 51 and the second output rotation shaft 52 are disconnected, according to, for example, an operation state of a switch for selection between a four-wheel-drive mode and a two-wheel-drive mode, the switch being operated by a driver.

FIG. 2 illustrates a state of meshing among the electric motor 2, the input gear 31, the idle gear 41, the first gear portion 431 and the second gear portion 432 of the high speed-side rotary member 43 and the large-diameter gear portion 421 of the multi-stage gear 42. In FIG. 2, the lower side of the drawing is the vertically lower side and the upper side of the drawing is the vertically upper side.

The input gear 31 rotates around a rotation axis O₁ of the motor shaft 24 of the electric motor 2 integrally with the motor shaft 24. The idle gear 41 includes gear teeth 41a that mesh with gear teeth 31a of the input gear 31 and gear teeth 431a of the first gear portion 431 of the high speed-side rotary member 43. The idle gear 41, which rotates around a rotation axis O₂, reduces a speed of rotation of the input gear 31 and transmits the resulting rotation to the first gear portion 431 of the high speed-side rotary member 43.

The high speed-side rotary member 43, the low speed-side rotary member 44 and the intermediate output member 45 rotate around a rotation axis O₃ of the intermediate output member 45 and the first and second output rotation shafts 51, 52. Hereinafter, the rotation axis O₃ is referred to as “output rotation axis O₃”. Gear teeth 432a of the second gear portion 432 of the high speed-side rotary member 43 mesh with gear teeth 421a of the large-diameter gear portion 421 of the multi-stage gear 42. The multi-stage gear 42 rotates around a rotation axis O₄ via a drive force of the electric motor 2, the drive force being transmitted from the second gear portion 432 of the high speed-side rotary member 43. Note that in FIG. 2, the first gear portion 431 and the second gear portion 432 of the high speed-side rotary member 43 overlap with each other.

The electric motor 2 is disposed such that the rotation axis O₁ of the motor shaft 24 is positioned in parallel with the output rotation axis O₃ and vertically above the output rotation axis O₃. Consequently, in comparison with a case where the electric motor 2 is disposed such that the rotation axis O₁ of the motor shaft 24 is positioned coaxially with the output rotation axis O₃ or horizontally aligned with the output rotation axis O₃, the electric motor 2 is disposed on the vertically upper side. Therefore, a minimum ground clearance of the front-and-rear-wheel-drive vehicle 1 is less likely to be limited by the electric motor 2. Thus, it is possible to enhance the front-and-rear-wheel-drive vehicle 1's capability of travelling on a rough road by increasing the minimum ground clearance.

### Second Embodiment

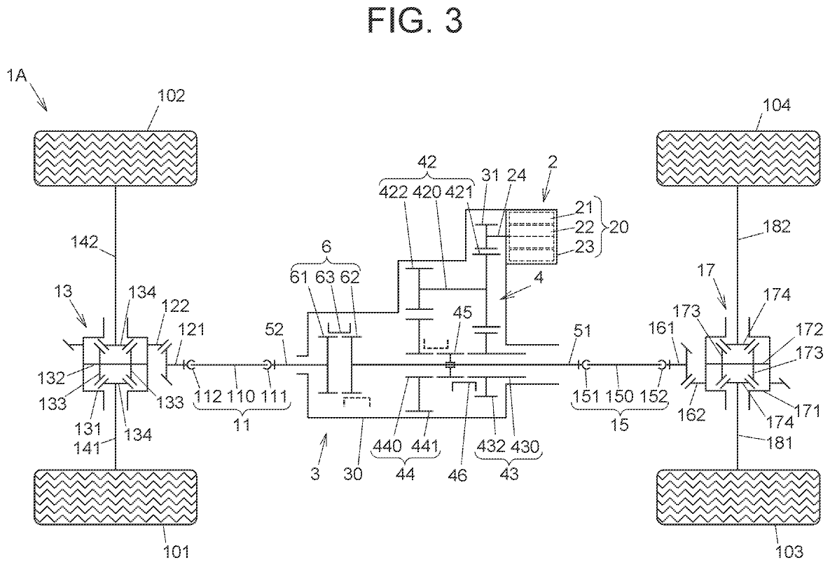

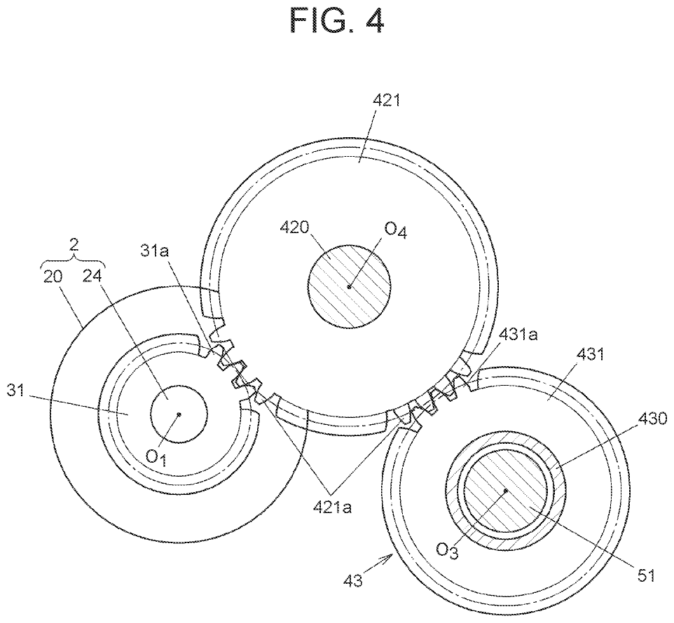

Next, a second embodiment of the disclosure will be described with reference to FIGS. 3 and 4. FIG. 3 is a schematic configuration diagram illustrating a configuration of a drive system of a front-and-rear-wheel-drive vehicle 1A according to a second embodiment of the disclosure. FIG. 4 is a configuration diagram illustrating a configuration of a part of a drive force distribution device 3 in the front-and-rear-wheel-drive vehicle 1A. In FIGS. 3 and 4, members that are in common with those described for the first embodiment with reference FIGS. 1 and 2 are provided with reference signs that are the same as those provided in FIGS. 1 and 2 and overlapping description thereof are omitted.

In the first embodiment, a case where a drive force of the electric motor 2 is transmitted to the multi-stage gear 42 through the idle gear 41 and the first gear portion 431 and the second gear portion 432 of the high speed-side rotary member 43 has been described. However, in the second embodiment, neither an idle gear 41 nor a first gear portion 431 of a high speed-side rotary member 43 is provided and an input gear 31 meshes with a large-diameter gear portion 421 of a multi-stage gear 42. A configuration of the rest of the front-and-rear-wheel-drive vehicle 1A is similar to that of the front-and-rear-wheel-drive vehicle 1 according to the first embodiment.

In the present embodiment, a drive force of an electric motor 2 is directly transmitted from the input gear 31 to the multi-stage gear 42. In a first connection state, the drive force of the electric motor 2 that has been transmitted to the multi-stage gear 42 is transmitted from the large-diameter gear portion 421 to an intermediate output member 45 through the high speed-side rotary member 43. On the other hand, in a second connection state, the drive force of the electric motor 2 that has been transmitted to the multi-stage gear 42 is transmitted from a small-diameter gear portion 422 to the intermediate output member 45 through a low speed-side rotary member 44. Therefore, as in the first embodiment, in the second connection state, a speed reducing ratio in the part from the input gear 31 to the intermediate output member 45 is large and the drive force of the electric motor 2 is largely amplified and then transmitted to the intermediate output member 45, in comparison with the first connection state.

As illustrated in FIG. 4, the electric motor 2 is disposed such that a rotation axis O₁ of a motor shaft 24 is positioned in parallel with an output rotation axis O₃ and vertically above the output rotation axis O₃. Therefore, as in the first embodiment, a minimum ground clearance of the front-and-rear-wheel-drive vehicle 1A is less likely to be limited by the electric motor 2. Thus, it is possible to enhance the front-and-rear-wheel-drive vehicle 1A's capability of travelling on a rough road by increasing the minimum ground clearance.

Also, in the present embodiment, since the input gear 31 meshes with the large-diameter gear portion 421 of the multi-stage gear 42, the drive force distribution device 3 is larger in length in a vehicle width direction but is smaller in length in a front-rear direction in comparison with the first embodiment. Also, since neither an idle gear 41 nor a first gear portion 431 of the high speed-side rotary member 43 is provided, the weight of the drive force distribution device 3 is reduced. Note that the input gear 31 may be configured to mesh with the small-diameter gear portion 422 of the multi-stage gear 42. In this case, an increase in size in the vehicle width direction of the drive force distribution device 3 can be curbed according to a difference in radius between the large-diameter gear portion 421 and the small-diameter gear portion 422.

### Third Embodiment

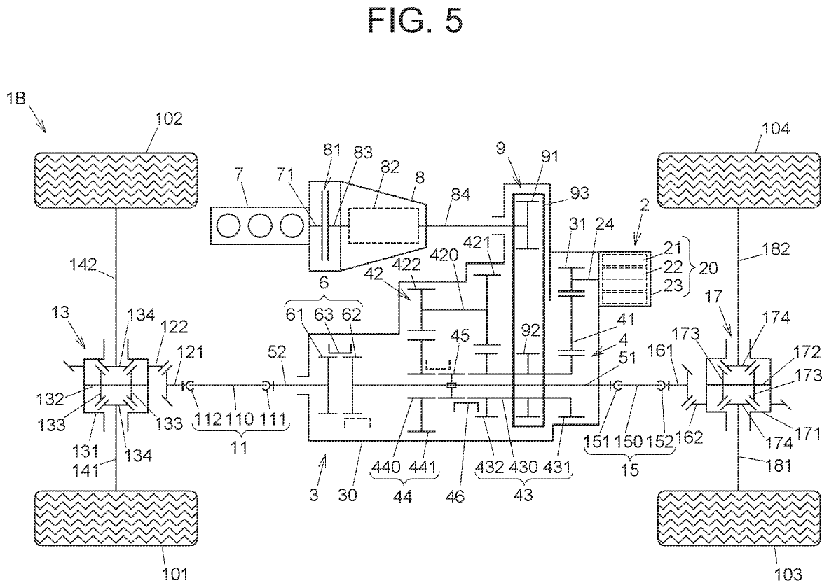

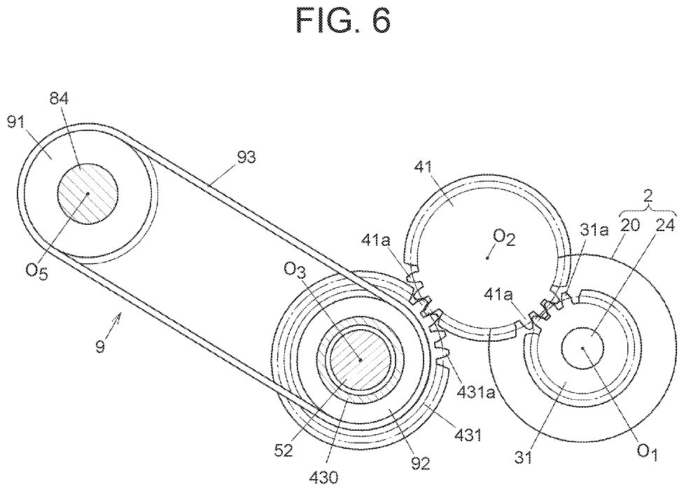

Next, a third embodiment of the disclosure will be described with reference to FIGS. 5 and 6. FIG. 5 is a schematic configuration diagram illustrating a configuration of a drive system of a front-and-rear-wheel-drive vehicle 1B according to a third embodiment of the disclosure. FIG. 6 is a configuration diagram illustrating a configuration of a part of a drive force distribution device 3 in the front-and-rear-wheel-drive vehicle 1B. In FIGS. 5 and 6, members that are in common with those described for the first embodiment with reference FIGS. 1 and 2 are provided with reference signs that are the same as those provided in FIGS. 1 and 2 and overlapping description thereof are omitted.

In each of the first and second embodiments, a case where the front-and-rear-wheel-drive vehicle 1, 1A includes the electric motor 2 alone as a drive source has been described. However, each of front-and-rear-wheel-drive vehicles 1B, 1C according to the third embodiment and a later-described fourth embodiment includes an engine 7 as a drive source in addition to an electric motor 2. The engine 7 is an internal combustion engine in which a liquid fuel such as gasoline is burned inside a cylinder to generate power.

A drive force of the engine 7 is input from an output rotation shaft 84 of a transmission 8 to the drive force distribution device 3 while the speed of the rotation is changed by the transmission 8. The transmission 8 includes a clutch 81 and a speed change mechanism 82. A crankshaft 71, which is an output rotation shaft of the engine 7, and an input rotation shaft 83 of the speed change mechanism 82 are connected and disconnected by the clutch 81. The engine 7 and the transmission 8 are longitudinally placed forward of the electric motor 2 and the drive force distribution device 3, and rotation axes of the crankshaft 71 and the output rotation shaft 84 of the transmission 8 are parallel to a vehicle front-rear direction.

The drive force distribution device 3 of the front-and-rear-wheel-drive vehicle 1B includes a chain mechanism 9 configured to transmit a drive force of the engine 7 to a high speed-side rotary member 43, in addition to the respective members described in the first embodiment. The chain mechanism 9 includes a first sprocket 91 fixed to the output rotation shaft 84 of the transmission 8, a second sprocket 92 fixed to a hollow connecting shaft 430 of the high speed-side rotary member 43, and a metal chain 93 that is an endless belt body having an annular shape, the endless belt body being looped around the first sprocket 91 and the second sprocket 92 such that the endless belt body rotates around the first sprocket 91 and the second sprocket 92. The second sprocket 92 is disposed between a first gear portion 431 and a second gear portion 432 of the high speed-side rotary member 43. Note that an example of the endless belt body is not limited to the chain 93 but may be a resin belt.

In a first connection state in which a sleeve 46 is located at a first connection position, respective drive forces of the electric motor 2 and the engine 7 are transmitted from the hollow connecting shaft 430 of the high speed-side rotary member 43 to an intermediate output member 45 through the sleeve 46. On the other hand, in a second connection state in which the sleeve 46 is located at a second connection position, respective drive forces of the electric motor 2 and the engine 7 are transmitted from the hollow connecting shaft 430 of the high speed-side rotary member 43 to the intermediate output member 45 through the second gear portion 432 of the high speed-side rotary member 43, a large-diameter gear portion 421 and a small-diameter gear portion 422 of a multi-stage gear 42, a gear portion 441 and a hollow connecting shaft 440 of a low speed-side rotary member 44 and the sleeve 46.

FIG. 6 illustrates a configuration of the electric motor 2, an input gear 31, an idle gear 41, the first gear portion 431 of the high speed-side rotary member 43 and the chain mechanism 9. In FIG. 6, the lower side in the drawing is the vertically lower side and the upper side in the drawing is the vertically upper side. A rotation axis O₅ of the first sprocket 91 is positioned vertically above a rotation axis O₁ of a motor shaft 24. The electric motor 2 is disposed such that the rotation axis O₁ of the motor shaft 24 is positioned in parallel with an output rotation axis O₃ of the intermediate output member 45 and first and second output rotation shafts 51, 52 and vertically above the output rotation axis O₃. Therefore, as in the first embodiment, a minimum ground clearance of the front-and-rear-wheel-drive vehicle 1B is less likely to be limited by the electric motor 2. Thus, it is possible to enhance the front-and-rear-wheel-drive vehicle 1B's ability of travelling on a rough road by increasing the minimum ground clearance.

Note that the second sprocket 92 may be fixed to the hollow connecting shaft 440 of the low speed-side rotary member 44. In this case, in the first connection state, a drive force of the engine 7 is amplified by the multi-stage gear 42 and transmitted to the high speed-side rotary member 43 and is then transmitted to the intermediate output member 45 through the sleeve 46. Also, the second sprocket 92 may be fixed to a connecting shaft 420 of the multi-stage gear 42.

### Fourth Embodiment

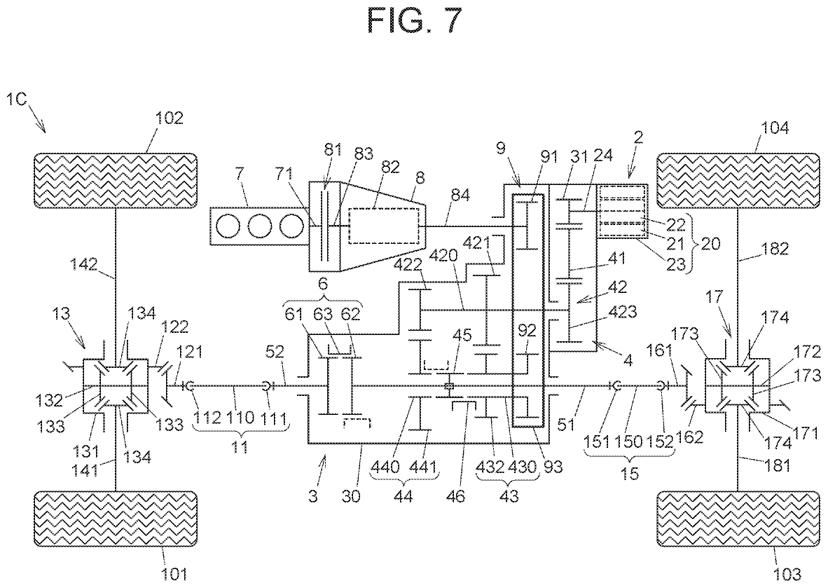

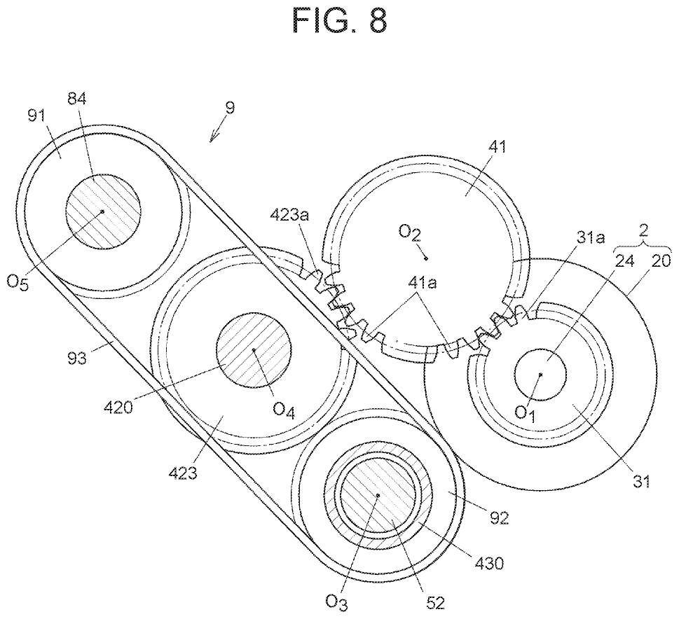

Next, a fourth embodiment of the disclosure will be described with reference to FIGS. 7 and 8. FIG. 7 is a schematic configuration diagram illustrating a configuration of a drive system of a front-and-rear-wheel-drive vehicle 1C according to a fourth embodiment of the disclosure. FIG. 8 is a configuration diagram illustrating a configuration of a part of a drive force distribution device 3 in the front-and-rear-wheel-drive vehicle 1C. In FIGS. 7 and 8, members that are in common with those described for the first embodiment or the third embodiment are provided with reference signs that are the same as those provided in FIGS. 1, 2, 5 and 6 and overlapping description thereof are omitted.

In the third embodiment, a case where a drive force of the electric motor 2 is transmitted from the idle gear 41 to the multi-stage gear 42 through the first gear portion 431 and the second gear portion 432 of the high speed-side rotary member 43 in the second connection state has been described. However, in the present embodiment, a multi-stage gear 42 includes a motor drive force input gear portion 423 that meshes with an idle gear 41 in addition to a large-diameter gear portion 421 and a small-diameter gear portion 422, and the motor drive force input gear portion 423 is connected to the large-diameter gear portion 421 and the small-diameter gear portion 422 by a connecting shaft 420 in such a manner as to rotate integrally with the large-diameter gear portion 421 and the small-diameter gear portion 422. Therefore, no first gear portion 431 is provided in a high speed-side rotary member 43.

In FIG. 8, the lower side in the drawing corresponds to the vertically lower side and the upper side in the drawing corresponds to the vertically upper side. Gear teeth 41a of the idle gear 41 mesh with gear teeth 423a of the motor drive force input gear portion 423. An electric motor 2 is disposed such that a rotation axis O₁ of a motor shaft 24 is positioned in parallel with an output rotation axis O₃ of an intermediate output member 45 and first and second output rotation shafts 51, 52 and vertically above the output rotation axis O₃. Therefore, as in the first embodiment, a minimum ground clearance of the front-and-rear-wheel-drive vehicle 1C is less likely to be limited by the electric motor 2. Thus, it is possible to enhance the front-and-rear-wheel-drive vehicle 1C's ability of travelling on a rough road by increasing the minimum ground clearance.

Also, as illustrated in FIG. 8, the connecting shaft 420 of the multi-stage gear 42 is inserted between a first sprocket 91 and a second sprocket 92 inside a chain 93. More specifically, a part of the connecting shaft 420 is inserted between the first sprocket 91 and the second sprocket 92 inside the chain 93, the part of the connecting shaft 420 being located between the large-diameter gear portion 421 and the small-diameter gear portion 422, and the motor drive force input gear portion 423. Consequently, in comparison with a case where the connecting shaft 420 of the multi-stage gear 42 is disposed vertically above or below the chain 93, a size of the drive force distribution device 3 in a height direction (an up-down direction) can be reduced. Thus, it is possible to easily secure a sufficient minimum ground clearance.

Although the disclosure has been described based on the first to fourth embodiments, these embodiments are not intended to limit the disclosure. Also, the disclosure can be carried out with any of the embodiments appropriately altered by omission of some components or addition or replacement of some components without departing from the scope of the disclosure. Also, furthermore, some of the components of the plurality of embodiments described above can be combined and can be altered, for example, as follows.

In each of the first to fourth embodiments, a case where a connection-disconnection clutch 6 is disposed between the first output rotation shaft 51 and the second output rotation shaft 52 has been described. However, the disclosure is not limited to this case, and for example, a wet multi-disc clutch to be pushed by an electromagnetic actuator may be disposed between the first output rotation shaft 51 and the second output rotation shaft 52. Also, for example, a differential device such as the front differential 13 or the rear differential 17 may be disposed between the first output rotation shaft 51 and the second output rotation shaft 52 and a differential case of the differential device may be connected to the intermediate output member 45 in such a manner as to be non-rotatable relative to the intermediate output member 45.

What is claimed is:

1. A front-and-rear-wheel-drive vehicle in which front wheels and rear wheels are configured to be driven, the front-and-rear-wheel-drive vehicle comprising:
an electric motor including a motor shaft that rotates when the electric motor is supplied with an electric current;
a speed change mechanism configured to change a speed of rotation of the motor shaft to a plurality of levels and to output resulting rotation from an intermediate output member;
a first output rotation shaft that transmits a drive force of the electric motor that has been transmitted to the intermediate output member, to one of a front wheel side and a rear wheel side; and
a second output rotation shaft that transmits the drive force of the electric motor that has been transmitted to the intermediate output member, to another of the front wheel side and the rear wheel side, wherein
the first and second output rotation shafts are disposed coaxially with the intermediate output member, and
the electric motor is disposed such that a rotation axis of the motor shaft is positioned in parallel with a rotation axis of the intermediate output member and the first and second output rotation shafts and vertically above the rotation axis of the intermediate output member and the first and second output rotation shafts.

2. The front-and-rear-wheel-drive vehicle according to claim 1, wherein:
the first output rotation shaft extends through the intermediate output member in a vehicle front-rear direction and is fitted to the intermediate output member in such a manner as to be non-rotatable relative to the intermediate output member; and
a connection-disconnection clutch switchable between a connection state in which the first output rotation shaft and the second output rotation shaft are connected in such a manner as to be non-rotatable relative to each other and a disconnection state in which the first output rotation shaft and the second output rotation shaft are disconnected is disposed between the first output rotation shaft and the second output rotation shaft.

3. The front-and-rear-wheel-drive vehicle according to claim 1, wherein:
the speed change mechanism includes a multi-stage gear including a large-diameter gear portion and a small-diameter gear portion having different pitch diameters, a high speed-side rotary member including a gear portion that meshes with the large-diameter gear portion, and a low speed-side rotary member including a gear portion that meshes with the small-diameter gear portion; and
the intermediate output member is connected to one of the high speed-side rotary member and the low speed-side rotary member in such a manner as to be non-rotatable relative to the one of the high speed-side rotary member and the low speed-side rotary member.

4. The front-and-rear-wheel-drive vehicle according to claim 3, wherein a drive force of an engine is transmitted to the high speed-side rotary member or the low speed-side rotary member.

5. The front-and-rear-wheel-drive vehicle according to claim 4, wherein:
the drive force of the engine is transmitted to the high speed-side rotary member or the low speed-side rotary member by a chain mechanism including first and second sprockets and an endless belt body having an annular shape, the endless belt body being looped around the first and second sprockets such that the endless belt body rotates around the first and second sprockets;
the multi-stage gear includes a connecting shaft connecting the large-diameter gear portion and the small-diameter gear portion; and
the connecting shaft is inserted between the first sprocket and the second sprocket inside the endless belt body.

6. The front-and-rear-wheel-drive vehicle according to claim 5, wherein:
the multi-stage gear includes a motor drive force input gear portion to which the drive force of the electric motor is transmitted;
the large-diameter gear portion and the small-diameter gear portion, and the motor drive force input gear portion are connected by the connecting shaft; and
a part of the connecting shaft is inserted between the first sprocket and the second sprocket inside the endless belt body, the part of the connecting shaft being located between the large-diameter gear portion and the small-diameter gear portion, and the motor drive force input gear portion.
